(19) United States
(12) Patent Application Publication
(10) Pub. No.: US 2004/0024807 A1
(43) Pub. Date: Feb. 5, 2004

(54) Asynchronous updates of weakly consistent distributed state information

(75) Inventors: Luis Felipe Cabrera, Bellevue, WA (US); David A. Wortendyke, Seattle, WA (US)

Correspondence Address: BANNER & WITCOFF LTD.,, ATTORNEYS FOR MICROSOFT, 1001 G STREET , N.W., ELEVENTH STREET, WASHINGTON, DC, 20001-4597, US

(73) Assignee: Microsoft Corporation, Redmond, WA

(21) Appl. No.: 10/210,517

(22) Filed: Jul. 31, 2002

(51) Int. Cl. G06F 15/16

(52) U.S. Cl. 709/201

(57) ABSTRACT

Information is disseminated, with weak consistency, across multiple computer systems. Update operations may be described in terms of a directed acyclic graph of update dependencies. Using techniques similar to operations logging, state information is recorded and preserved through information units at a particular update operation's primary site. Subsequent processing of these information units at the primary site then initiates dissemination of the state information to zero or more dependent sites. Accordingly, an update operation may happen first at its primary site. Then, in a delayed manner, the state information may be updated in the dependent sites thereby eventually synchronizing the over-all state of the system. Upon cessation of update operations of this type, the system will eventually reach a self-consistent stable state.

### TECHNICAL FIELD

The invention relates generally to updating information stored in a distributed manner across multiple computers. More particularly, the invention relates to asynchronously updating weakly consistent distributed state information.

### BACKGROUND OF THE INVENTION

Various computer-system operations may involve maintaining related state information by multiple computer systems in multiple locations. Updating this related state information in a strongly consistent manner typically requires simultaneously holding locks at the various locations so that updates are reflected immediately at each location upon completion of the update operation. Simultaneously holding locks in this manner reduces the availability of the system because if one of the computer systems is down (i.e., non-operational) or too busy to enable an update to the state information, then the complete update operation cannot proceed.

Substantially continuous availability of computer systems, such as computer systems providing Web services, is becoming increasingly important in many computer-system applications. An ability to scale-out is also desirable. In the context of Web services, scaling-out refers to being able to use a variable number of computers for operating a service such that the number of computers can be efficiently increased or decreased as desired. For instance, to accommodate a surge in demand, more computers may be devoted to operate a service, and vice versa. In a situation where state information of a Web service is placed in several computer systems, updating the state information with conventional strongly consistent techniques may have adverse affects on the availability of the service. These strongly consistent conventional update techniques typically require that the complete collection of computers that participate in the update of state information be operational simultaneously while the update is in progress. Thus the probability of not being able to provide update service increases with the number of computers that have to handle the data. This works against the goal of being able to scale out efficiently by having additional computers operate on the same data.

Further, when data is to be stored at a set of distinct data storage locations, inevitably the overall state of the system will not remain in perfect synchronization at all times. Hence, in such systems, it is typically not practical to try to have strong mutual consistency at all times. This assertion typically holds true even when trying to perform individual updates to state information under tightly coupled strongly consistent update conditions. When recovering from a storage system failure, for example, the restoration process may bring a data store to a point in time that is older than the rest of the system, and thus a state inconsistency is achieved.

Accordingly, it would be desirable to update distributed information in a manner that avoids the undesirable effects, discussed above, associated with conventional strongly consistent-update techniques.

### SUMMARY OF THE INVENTION

A system and method in accordance with the present invention overcomes the foregoing shortcomings of conventional techniques for updating distributed state information in a strongly consistent manner.

In accordance with the invention, information is disseminated, with weak consistency, across multiple computer systems that may be grossly distributed. In this context, weak consistency refers to allowing updates to distributed state information to occur at any particular site asynchronously with respect to updates performed at other sites.

Using techniques similar to operations logging, state information is recorded and preserved at a particular update operation's primary site. Subsequent processing of this information at the primary site may then initiate dissemination of the state information to one or more dependent sites. Accordingly, an update operation may happen first at its primary site. Then, in a delayed manner, the state information may be updated in the dependent sites thereby eventually synchronizing the over-all state of the system.

In accordance with an illustrative embodiment of the invention, an update operation for distributed state information may be performed as follows. First, a primary site for the operation, also referred to as a primary information-storage site or a primary computer system, stores information associated with the update operation. The primary site may then reliably disseminate pertinent information to zero or more other sites, which may be referred to as dependent sites, dependent computer systems, or dependent-information storage sites. In this manner, the state information gets disseminated in stages, in a delayed manner, over the collection of locations to which it pertains. While this approach maximizes the availability of a service or system of computers, the distributed state information may not be simultaneously up-to-date at all of the sites in the system. Temporary inconsistency of this type is referred to herein as weak consistency.

In accordance with various inventive principles, upon cessation of update operations of this type, the system will eventually reach a self-consistent stable state.

In accordance with an illustrative embodiment of the invention, update operations may be described in terms of a directed acyclic graph of update dependencies.

In accordance with an illustrative embodiment of the invention, updated state information sufficient to specify a substantially complete update operation may be stored at the primary site. Stated differently, in addition to storing the updated state information that is targeted to the primary site, the operation may also store at the primary site information targeted for storage at the operation's dependent sites.

Data to be processed at dependent sites may be referred to as dependent data, which in accordance with various inventive principles may be managed asynchronously in a delayed manner. Dependent data may be durably stored, in a manner similar to storage of “intention records,” at the primary site before being sent to one or more dependent sites.

Before sending dependent data from a primary site to a dependent site, the primary site may durably store information indicating that the primary site is going to send dependent data to the dependent site. After sending the dependent data to the dependent site, the primary site may then durably store information indicating that the dependent data was sent. Upon receiving an indication from the dependent site that the dependent site has accepted the dependent data and/or has completed any dependent update operations associated with the dependent data, the primary site may durably store information indicating acceptance of the dependent data and/or completion of the dependent operation by the dependent site.

In a recursive manner, for a multi-site multi-step update operation, a dependent site for a given step may become a primary site for the next step of the update operation. A site that transitions from being a dependent site for a previous step of an update operation to a primary site of a current step of an update operation may durably store substantially all of the information to be used at both the primary site and the dependent sites for the current step of the update operation.

Compensation actions may be taken upon occurrence of various types of failures. For instance, update operations may be preserved by durably storing information indicating: an intention to perform update operations; and that the update operations have been performed. Then, upon detecting that, due to a failure, state information stored at a primary site is out of synchronization with state information stored at a dependent site, the primary site may replay update operations to a dependent site, for instance. This type of update processing by the primary site, in response to a fault at a dependent site, is advantageously very similar to the way the primary site performs normal update processing in the absence of failures.

The state information stored at a primary site and the state information stored at a dependent site may also get out of synchronization when either site has been temporarily unavailable. Upon detecting an out-of-synchronization condition, primary and/or dependent sites may take compensatory action to restore synchronization relative to each other. For instance, a dependent site may request state information from a primary site upon determining that the dependent site might be behind in time relative to the primary site. This may occur upon a dependent site starting up, recovering from a failure, or re-establishing a connection with the primary site. When the primary site is behind in time relative to at least one of the dependent sites, then compensatory actions may be taken to roll back in time state information stored by one or more dependent sites.

Update operations may have their own unique identifiers. In information units durably stored at primary and/or dependent sites, instances of operations may be identified by unique sequence numbers. Primary and/or dependent sites may then track these unique identifiers so that these sites may avoid undesirably repeating operations that should not be repeated. The time series of these log records allows selectively replaying of operations as desired. Even though there is a causal relationship in which one operation happened before another, which happened before yet another operation. Assigning sequence numbers to each instance of operations advantageously creates a type of logical clock that is independent of time-synchronization. This type of sequencing of operations advantageously allows primary and dependent sites to track the linear ordering, or sequence, of operations without dependence on time as measured by a clock.

Additional features and advantages of the invention will be apparent upon reviewing the following detailed description.

### BRIEF DESCRIPTION OF THE DRAWINGS

FIG. 1 illustrates an exemplary distributed computing system operating enviromnent; that can be used to implement various aspects of the present invention.

FIG. 2 is a simplified schematic diagram of a directed acyclic graph of dependencies.

FIGS. 3A-3E show various types of dependencies for a primary site and two dependent sites.

FIG. 4 is a schematic block diagram of an exemplary system in accordance with an illustrative embodiment of the invention.

FIG. 5 is a flowchart showing steps that may be performed by a primary computer system in accordance with an illustrative embodiment of the invention.

FIG. 6 is a flowchart showing steps that may be performed by a dependent computer system in accordance with an illustrative embodiment of the invention.

### DETAILED DESCRIPTION OF THE INVENTION

In accordance with the invention, information is disseminated, with weak consistency, across multiple computer systems that may be grossly distributed. In this context, weak consistency refers to allowing updates to distributed state information to occur at any particular site asynchronously with respect to updates performed at other sites.

Using techniques similar to operations logging, as described in Gray and Reuter, Transaction Processing: Concepts and Techniques (Morgan Kaufmann Publishers 1993), state information is recorded and preserved at a particular update operation's primary site. Subsequent processing of this information at the primary site may then initiate dissemination of the state information to one or more dependent sites. Accordingly, an update operation may happen first at its primary site. Then, in a delayed manner, the state information may be updated in the dependent sites thereby eventually synchronizing the over-all state of the system.

Aspects of the invention are suitable for use in a variety of distributed computing system environments. In distributed computing environments, tasks may be performed by remote computer devices that are linked through communications networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, network PCS, minicomputers, mainframe computers, and the like.

The invention will be described in the general context of computer-executable instructions, such as program modules, that are executed by a personal computer or a server. Generally, program modules include routines, programs, objects, components, data structures, etc., that perform particular tasks or implement particular abstract data types. Typically the functionality of the program modules may be combined or distributed as desired in various environments.

Embodiments within the scope of the present invention also include computer readable media having executable instructions. Such computer readable media can be any available media, which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

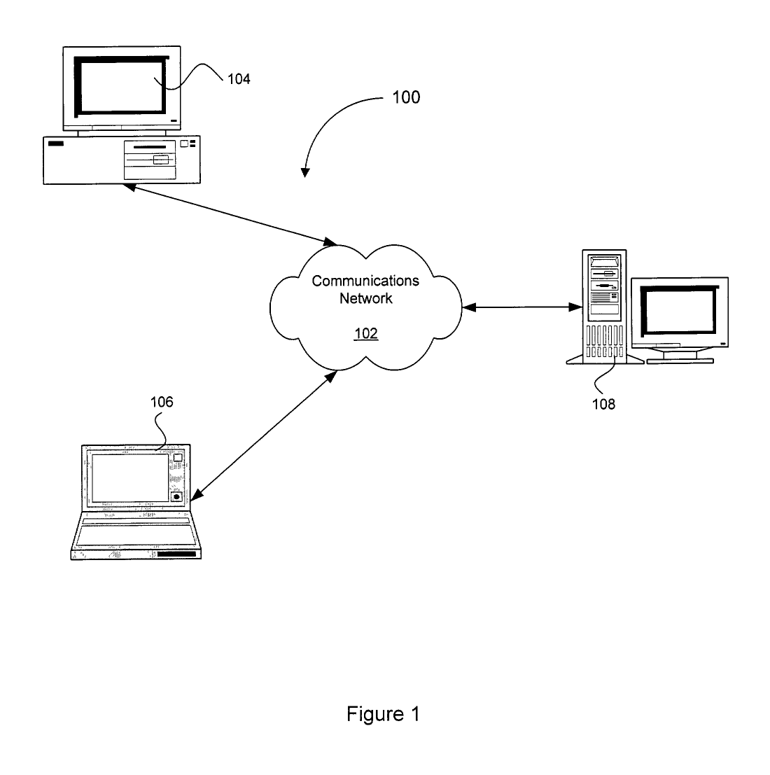

FIG. 1 illustrates an example of a suitable distributed computing system 100 operating environment in which the invention may be implemented. Distributed computing system 100 is only one example of a suitable operating environment and is not intended to suggest any limitation as to the scope of use or functionality of the invention. System 100 is shown as including a communications network 102. The specific network implementation used can be comprised of, for example, any type of local area network (LAN) and associated LAN topologies and protocols; simple point-to-point networks (such as direct modem-to-modem connection); and wide area network (WAN) implementations, including public Internets and commercial based network services. Systems may also include more than one communication network, such as a LAN coupled to the Internet

Computer device 104, computer device 106, and computer device 108 may be coupled to communications network 102 through communication devices. Network interfaces or adapters may be used to connect computer devices 104, 106, and 108 to a LAN. When communications network 102 includes a WAN, modems or other means for establishing communications over WANs may be utilized. Computer devices 104, 106 and 108 may communicate with one another via communication network 102 in ways that are well known in the art. The existence of any of various well-known protocols, such as TCP/IP, Ethernet, FTP, HTTP and the like, is presumed.

Computers devices 104, 106 and 108 may exchange content, applications, messages and other objects via communications network 102. In some aspects of the invention, computer device 108 may be implemented with a server computer or server farm. Computer device 108 may also be configured to provide services to computer devices 104 and 106. Alternatively, computing devices 104, 106, and 108 may also be arranged in a peer-to-peer arrangement in which, for a given operation, ad-hoc relationships among the computing devices may be formed.

In accordance with an illustrative embodiment of the invention, an update operation for distributed state information may be performed as follows. First, a primary site for the operation, also referred to as a primary information-storage site or a primary computer system, durably stores information associated with the update operation. The primary site may then reliably disseminate pertinent information to zero or more other sites, which may be referred to as dependent sites, dependent computer systems, or dependent-information storage sites. In this manner, the state information gets disseminated in stages, in a delayed manner, over the collection of locations to which it pertains. While this approach maximizes the availability of a service or system of computers, the distributed state information may not be simultaneously up-to-date at all of the sites in the system. Temporary inconsistency of this type is referred to herein as weak consistency.

In accordance with various inventive principles, upon cessation of update operations of this type, the system will eventually reach a self-consistent stable state. As an extremely simplified example to illustrate the difference between an internally consistent state and an internally inconsistent state, suppose a system includes three computers that each includes a copy of a list identifying a set of networked computers. When a new computer is added to the network, the three lists may become temporarily inconsistent with the networked computers actually in the system. As the lists stored by the three computers get updated one-by-one, the inconsistency of the system is gradually reduced until, when all three of the lists are updated to include the newly added computer, the system reaches an internally consistent state.

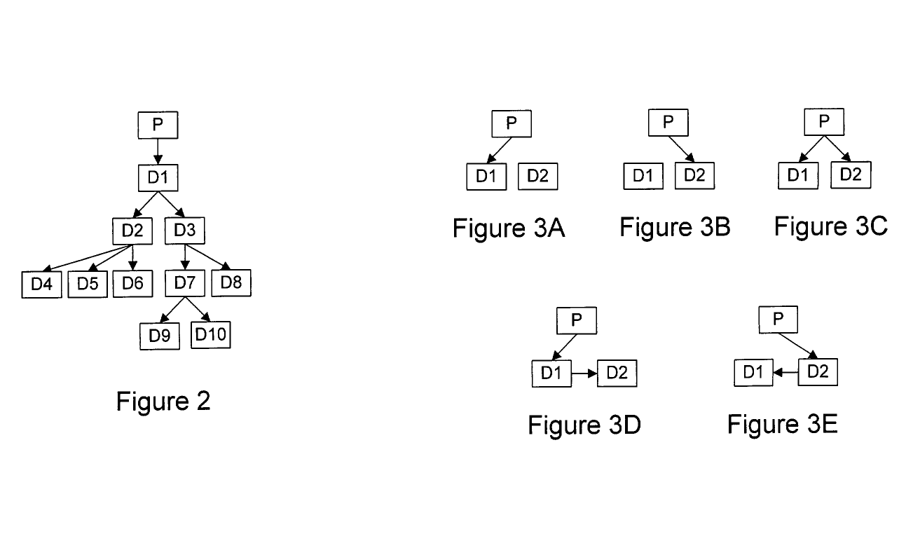

In accordance with an illustrative embodiment of the invention, update operations may be described in terms of a directed acyclic graph of update dependencies. A simplified example of a directed acyclic graph is shown in FIG. 2. Such a graph may be like a tree, such as a binary tree, with any number of child nodes depending from a parent node. For instance, D1 depends from P, and D4-D6 depend from D2. “Acyclic” refers to the absence of cycles, or looping back, within the tree.

FIGS. 3A-3E each depict a schematic block diagram of a system having a primary site P and two dependent sites D1 and D2 for various update operations. FIG. 3A shows D1, but not D2, as a dependent site for a first update operation. FIG. 3B shows D2, but not D1, as a dependent site for a second update operation. FIG. 3C shows D1 and D2 as dependent sites for a third update operation.

FIG. 3D shows D1, as a dependent site for a first step of a fourth update operation. In FIG. 3D, D1 also serves as the primary site for a second step of the fourth operation. For this second step, D2 is the dependent site.

FIG. 3E shows D2, as a dependent site for a first step of a fifth update operation. In FIG. 3E, D2 also serves as the primary site for a second step of the fifth operation. For this second step, D1 is the dependent site.

An update operation refers to an update operation of state information that may be distributed across multiple sites. An update operation may include one or more primary operations to be performed by the primary site and/or one or more dependent operations to be performed by one or more dependent sites. Instances of update operations, including primary operations, and dependent operations, may be serialized at the primary and dependent sites for an operation. In accordance with the invention, there may be no time limit imposed for how long it takes to finish disseminating updates to various dependent sites.

For a particular update operation, state information may be local to the primary site, without any state information stored at a dependent site. Under these circumstances, state information stored at the primary site is updated locally without initiating dissemination of state information to any dependent sites.

In accordance with an illustrative embodiment of the invention, updated state information sufficient to specify a substantially complete update operation may be stored at the primary site. Stated differently, in addition to storing the updated state information that is targeted to the primary site, the operation may also store at the primary site information targeted for storage at the operation's dependent sites. Thus, upon occurrence of various types of faults, the state information stored at an update operation's primary site may be used for reconstructing the update operation. Re-construction of state information for a dependent site of an update operation may occur at a remote computer that did not participate when the update operation was originally performed. Replacing a dependent computer system in this manner may be done at a geographically arbitrary place.

Data to be processed at dependent sites may be referred to as dependent data, which in accordance with various inventive principles may be managed asynchronously in a delayed manner. Dependent data may be durably preserved, in a manner similar to recording “intention records,” at the primary site before being sent to one or more dependent sites.

Before sending dependent data from a primary site to a dependent site, the primary site may durably store an information unit indicating that the primary site is going to send dependent data to the dependent site. After sending the dependent data to the dependent site, the primary site may then write a log record indicating that the dependent data was sent. Upon receiving an indication from the dependent site that the dependent site has accepted the dependent data and/or has completed any dependent update operations associated with the dependent data, the primary site may durably store an information unit indicating acceptance of the dependent data and/or completion of the dependent operation by the dependent site.

In accordance with an illustrative embodiment of the invention, primary and/or dependent data may be self-describing to allow unambiguous correlation of operations and collation of operations. The state information stored at the primary site, which describes state information stored, and/or to be stored, at the dependent sites, may be divided into logical units each targeted to a particular dependent site.

As a failure may happen at any point in a discrete chain of updates, compensation operations that should occur upon a failure, such as re-starting dissemination of information to one or more dependent sites, may be specified. These compensation actions may be stored in a durable manner. By durably preserving the compensation actions and other state information, the system may recover from various types of failures, including, but not limited to, arbitrary media failures. As used herein, the phrase, “stored in a durable manner” and similar such phrases refer to techniques, including, but not limited to, ACID (atomic, consistent, isolated, and durable) transaction-processing techniques for performing operations in an all-or-nothing manner such that state information for the transaction, or operation, may be recovered from a fault.

In a recursive manner, for a multi-site multi-step update operation, a dependent site for a given step becomes a primary site for the next step of the update operation. Multiple update operations from a particular primary site to a particular secondary site may be batched or grouped together, rather than each such update operation being sent individually. A site that transitions from being a dependent site for a previous step of an update operation to a primary site of a current step of an update operation may durably store substantially all of the information to be used at both the primary site and the dependent sites for the current step of the update operation.

Compensation actions may be taken upon occurrence of various types of failures. For instance, update operations may be preserved by durably storing information indicating: an intention to perform update operations; and that the update operations have been performed. Then, upon detecting that, due to a failure, state information stored at a primary site is out of synchronization with state information stored at a dependent site, the primary site may replay update operations to a dependent site, for instance. This type of update processing by the primary site, in response to a fault at a dependent site, is advantageously very similar to the way the primary site performs normal update processing in the absence of failures.

The state information stored at a primary site and the state information stored at a dependent site may also get out of synchronization when either site has been temporarily unavailable. Upon detecting an out-of-synchronization condition, primary and/or dependent sites may take compensatory action to restore synchronization relative to each other. For instance, a dependent site may request state information from a primary site upon determining that the dependent site might be behind in time relative to the primary site. This may occur upon a dependent site starting up, recovering from a failure, or re-establishing a connection with the primary site. When the primary site is behind in time relative to at least one of the dependent sites, then compensatory actions may be taken to roll back in time state information stored by one or more dependent sites.

Update operations may have their own unique identifiers. In information units durably stored at primary and/or dependent sites, instances of operations may be identified by unique sequence numbers, which may be assigned in a decentralized manner to avoid ambiguities when remotely processing the information units. Primary and/or dependent sites may then track these unique identifiers so that these sites may avoid undesirably repeating operations that should not be repeated. The time series of these log records allows selectively replaying of operations as desired. Even though there is a causal relationship in which one operation happened before another, which happened before yet another operation. Assigning sequence numbers to each instance of operations advantageously creates a type of logical clock that is independent of time-synchronization. This type of sequencing of operations advantageously allows primary and dependent sites to track the linear ordering, or sequence, of operations without dependence on time as measured by a clock.

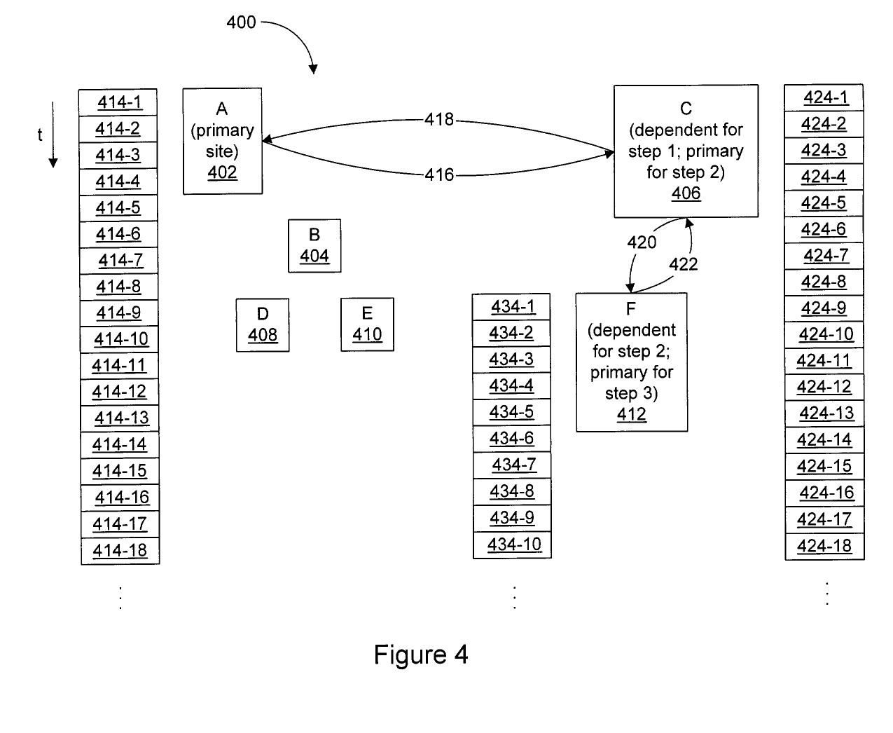

FIG. 4 shows a schematic block diagram of an exemplary system 400 of computers, in accordance with various inventive principles, for managing distributed state information in the context of managing newsgroup subscriptions. The example provided above of maintaining three copies of a list of computers in a network was very simple in that each of the three computers simply had a copy of the list. In other words, the same information was replicated in each location. In the exemplary system 400, though, different data, or subsets of data, may be stored at various information-storage sites.

For illustrative purposes, suppose computer system A 402, has stored a list of the names of various news groups that are managed by the system 400. Computer B 404 could be responsible for storing a list of people who live in the United States and who subscribe to two different news groups managed by the system 400. Computer C 406 could be responsible for storing a list of anyone living in Europe who subscribes to any of the managed news groups. Computer D 408 could be responsible for storing a list of people who live in the United States and who subscribe to any news group other than the two corresponding news groups handled by computer B 404. Computer E 410 could be responsible for storing a list of all subscribers other than those on the lists stored by computers A-D. Computer F 412 could be responsible for storing a tally of any subscribers who live in the western hemisphere. So with computers A-F, the system 400 manages information pertaining to which newsgroups exist and who subscribes to each of the newsgroups.

Computer A 402 could be the primary site for an “addnewsgroup” operation to add a new group to the list of newsgroups the system 400 manages. Suppose, that computer A 402 also stores a tally of how many subscribers are in each list. Computer A 402 may be used as the primary site for keeping this tally.

Upon receiving a request to subscribe someone new to a managed newsgroup, Computer A 402 will perform any local processing, which may include incrementing the tally for the requested newsgroup by one. Before incrementing the tally, computer A may durably store an information unit indicating an intention to increment the tally. After incrementing the tally, computer A may then durably store an information unit indicating that the tally was incremented. These types of information units (to indicate an intention to perform an operation and to indicate that an operation has been performed) may be stored, for instance, as log records or in individual files, which may have use unique file names for indicating a sequence in which the information units were stored to the individual files. Durably stored information units for Computer A 402 are represented by 414-1 through 414-18 in FIG. 4. The ellipsis below these information units indicates that additional log records may exist, but are not shown.

After incrementing the tally, computer A 402 may determine that dependent data should be sent to one or more dependent sites. For instance, if the subscription request being processed is from a person who lives in Europe, then computer A 402 would determine, in accordance with a pre-defined and previously stored directed acyclic graph of update dependencies for the subscribe operation, that dependent data stored at computer A 402 should be sent to Computer C 406. In a manner similar to that discussed above with respect to incrementing the tally, computer A may durably store an information unit indicating an intention to send the dependent data to computer C 406, which is a dependent site for the subscribe operation being processed. Computer A 402 may then send the dependent data for this subscribe operation to the computer C 406 as indicated by arrow 416 in FIG. 4. After sending this dependent data to computer C 406, computer A may then durably store an information unit indicating that the dependent data has been sent to computer C 406.

Upon receiving an indication from computer 406 that computer C 406 has received, accepted, and/or written the dependent data to computer C's log, as indicated by arrow 418, computer A may store a corresponding information unit to indicate that computer A received such an indication from computer C 406. Similarly, computer C may provide an indication to computer A that computer C 406 has successfully finished processing the dependent data for this operation. Upon receiving such an indication from computer C 406, computer A may store a corresponding information unit.

The next step for this subscribe operation will then be at computer C 406. The dependent data received from computer A 402 and stored by computer C 406 may include information such as which list the subscription request is for, the subscriber's location, and the like. The dependent data may also include a dependent-operation description indicating what type of operation, or operations, computer C 406 should perform, which in this example include adding a new subscription.

Computer C 406 then processes the dependent data received from computer A 402 in a similar manner to how computer A performed its processing, as described above. Computer C 406 may perform any local operations, such as adding the subscription, and may durably store appropriate information units, represented by 424-41 through 424-18, in a manner similar to the manner discussed above in connection with computer A 402, to indicate an intention to perform the local processing and that the local processing has been completed.

During the first step of this subscribe operation, computer A 402 was the primary site and computer C 406 was the dependent site. For the second step, though, computer C 406 is the primary site, and computer F 412 is a dependent site. Because the subscription request in the example is for someone from Europe, computer C 406 would send dependent data, as indicated by arrow 420, to computer F 412, indicating that computer F should increment the tally of western-hemisphere subscribers. Upon receiving notification, as indicated by arrow 422, that computer F 412 has accepted the dependent data from computer C 406, then computer C 406 may durably store a corresponding information unit.

Computer F 412 will then be the primary site for the third step of the subscribe operation in the example. In this example, the third step is the final step of the operation and involves only local processing, namely incrementing the western-hemisphere tally. As was the case for the local processing performed by computers A 402 and C 406, computer F 412 may durably store appropriate information units, represented by 434-1 through 434-10, to indicate an intention to perform its local processing and to indicate that its local processing has been done.

In the manner described above, the subscribe operation of the example that occurred first at computer A 402 eventually percolates through the system 400 so that a snapshot of the system 400 would reflect a self-consistent view. While computers A 402, C 406, and F 412 are processing the subscribe information, the information kept at computers A 402, C 406, and F 412, about the number of subscriptions, may not agree. But once computers A 402, C 406, and F 412 have finished their processing, then the information will agree, thereby putting the system into a self-consistent state.

Time proceeds downwardly in the information units shown in FIG. 4, as indicated to the left of log records 414-1 through 414-18. At any moment, any of the computers in the system 400 may loose some memory due to a failure. Suppose computer C 406 is not operating for two weeks. When computer A 402 realizes that computer C has started operating again, computer A 402 may determine when the last time computer C 406 accepted dependent data from computer A 402. Computer A 402 may then proceed from that point in its information units forward sending to computer C 406 dependent data targeted for computer C 406. In this manner, computer C's state information will then eventually converge to consistency with computer A's state information. This type of update processing by computer A 402, in response to a fault at computer C 406, is advantageously very similar to the way computer A 402 performs normal update processing pertaining to disseminating dependent data to a particular dependent site in the absence of any faults.

If computer C 406 experiences a catastrophic failure, computer C 406 may request that computer A 402 re-send dependent data previously sent by computer A 402 to computer C 406. Computer A 402 may do this by going back to an appropriate location in its durably stored information units, and re-sending pertinent dependent data to computer C 406 in accordance with A's durably stored information units.

By using backups and/or checkpoints of stored state information, the amount of stored information that may need to be re-sent, in the event of a failure, may be reduced relative to the amount of stored information that would otherwise be re-sent. Backups of stored state information may be performed periodically and/or at any other suitable times. Backups, which are well known in the art, refer to transferring a copy of stored information to a new location. This typically protects the backed-up information from loss due to media failures. Checkpoints may be used to reduce the amount of state information to be retained. A checkpoint may serve essentially as a summary of state information that came before the checkpoint. Checkpoints, like other stored state information, may be backed up.

To facilitate identifying pertinent durably stored information units for fault-recovery purposes, well-understood techniques of uniquely identifying specific operations and instances of operations, such as assigning sequence numbers, may be used. Each operation, such as addnewsgroup, subscribe, unsubscribe, may have its own unique identifier. In the durably stored information units, each instance of each operation may get its own unique sequence number. Primary and/or dependent sites may then track these unique identifiers so that these sites may avoid undesirably repeating operations that should not be repeated. The time series of these durably stored information units allows selectively replaying of operations as desired.

Even though there is a causal relationship in which one operation happened before another, which happened before yet another operation. Assigning sequence numbers to each instance of operations advantageously creates a type of logical clock that is independent of time-synchronization. For instance, instances of the addnewsgroup operation could be assigned sequence codes/numbers ANG1, ANG2, ANG3 . . . Computers within the system 400 will then be able to recognize that ANG2 happened after ANG1. If computer C 406 receives ANG4 without having already received ANG3, then computer C 406 may notify computer A 402 that computer C 406 didn't receive ANG3. In this manner, sequence numbers of this type advantageously create an ability to sequence correctly with respect to the causal ordering of operations. The sequence numbers also allow a dependent site, which may be geographically remote (e.g., on a different continent) from a primary site, to detect gaps in dependent data, which indicate lost information. This type of sequencing of operations allows computers in the system 400 to track the linear ordering, or sequence, of operations without dependence on time as measured by a clock.

Suppose computer C 406 realizes that computer F 412 is failing to accept data or perform an operation, then computer C may perform some processing that is local to computer C 406 and may also notify computer A 402 that computer F 412 has failed one or more operations. Local processing performed by computer C 406 may include durably storing information units to indicate: an intention to perform the local processing and to notify computer A 402 of the failure; and that the local processing and notification of computer A 402 have been completed. This type of compensatory action may occur asynchronously such that the system 400 will eventually converge to a self-consistent state.

Suppose computer A 402 gets a subscribe-operation request followed by an unsubscribe-operation request that effectively cancels the subscribe operation request. If computer A 402 has not yet sent dependent data to computer C 406 for the subscribe operation, then computer A 402 may durably store an information unit indicating an intention to cancel both the subscribe and unsubscribe operations. After canceling the operations, computer A 402 may durably store another information unit indicating that the operations have been cancelled.

System-synchronization state information may be maintained for efficiently verifying whether or not primary data and dependent data are synchronized. For instance, a primary site may register a dependency with various sites that are dependent relative to the primary site. The dependent sites may use this registered dependency information for requesting dependent data stored at the primary site. When making such a request, a dependent site may provide to the primary site the dependent site's current state information for one or more operations.

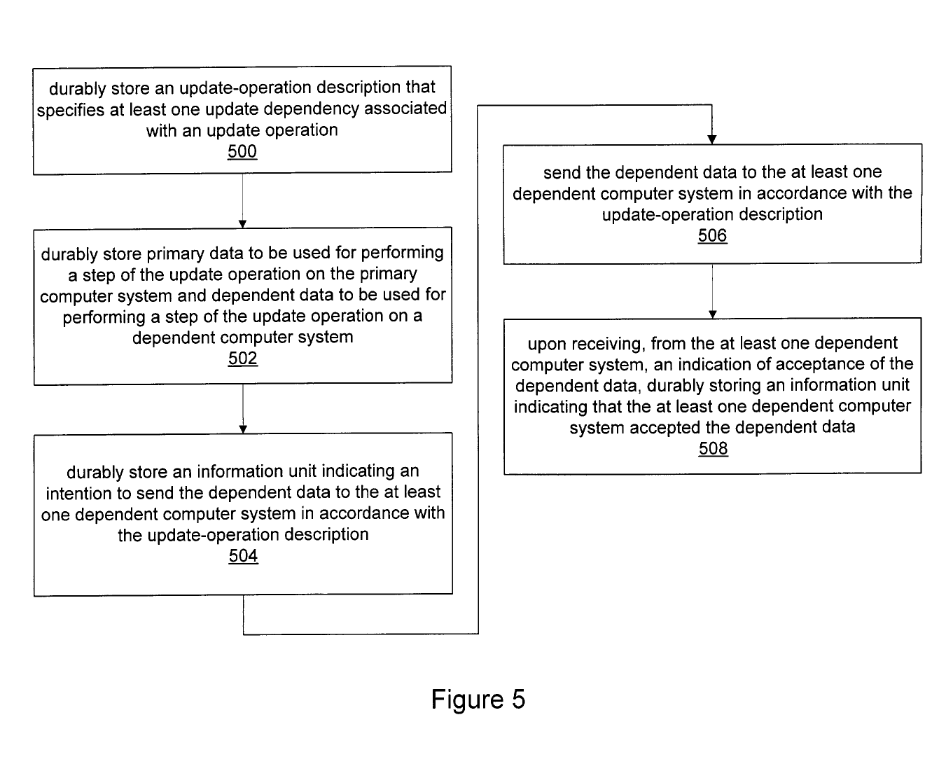

FIG. 5 is a flowchart showing steps that may be performed by an update operation's primary computer system in accordance with an illustrative embodiment of the invention. As shown at step 500, an update-operation description, which specifies at least one update dependency associated with an update operation, is durably stored.

At step 502, primary data to be used for performing a step of the update operation on the primary computer system and dependent data to be used for performing a step of the update operation on a dependent computer system are durably stored. At step 504, an information unit, which indicates an intention to send the dependent data to the at least one dependent computer system in accordance with the update-operation description, is durably stored. At step 506, the dependent data is sent to the at least one dependent computer system in accordance with the update-operation description. At step 508, upon receiving, from the at least one dependent computer system, an indication of acceptance of the dependent data, an information unit, which indicates that the at least one dependent computer system accepted the dependent data, is durably stored.

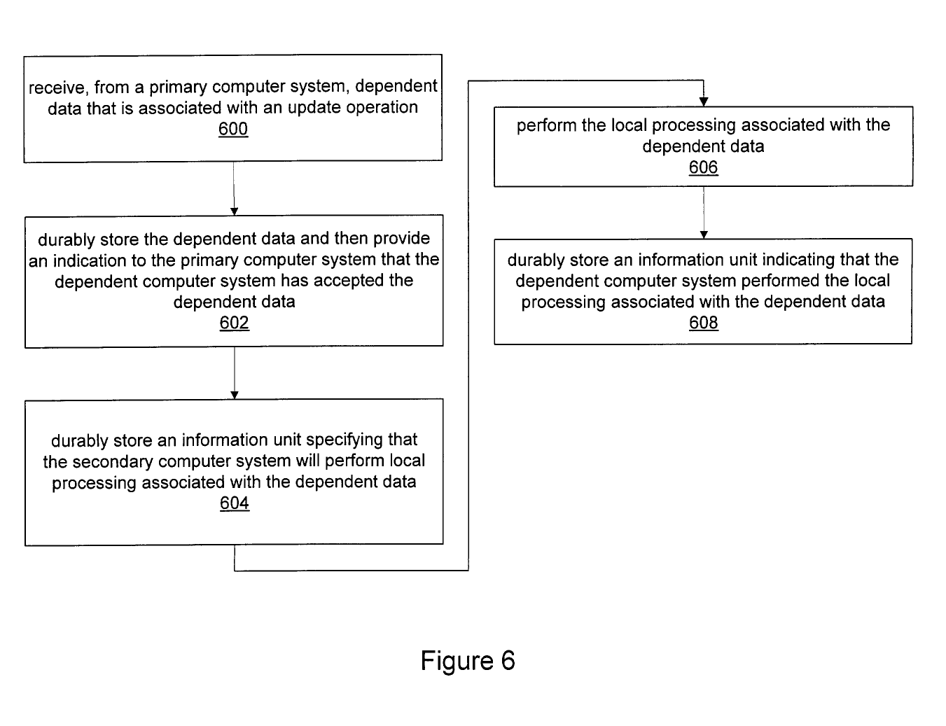

FIG. 6 is a flowchart showing steps that may be performed by a dependent computer system of an update operation in accordance with an illustrative embodiment of the invention. As shown at step 600, dependent data, which is associated with an update operation, is received from a primary computer system. As shown at step 602, the dependent data is durably stored and then an indication is provided to the primary computer system that the dependent computer system has accepted the dependent data. At step 604, an information unit, which specifies that the secondary computer system will perform local processing associated with the dependent data, is durably stored. As shown at step 606, local processing, which is associated with the dependent data, is performed. As shown at step 608, an information unit, which indicates that the dependent computer system performed the local processing associated with the dependent data, is durably stored.

What has been described above is illustrative of the application of various inventive principles. Those skilled in the art can implement other arrangements and methods without departing from the spirit and scope of the present invention, as defined by the claims below and their equivalents. Any of the methods of the invention can be implemented in software that can be stored on computer disks or other computer-readable media.

We Claim:

1. A method, performed by a primary computer system, of asynchronously performing an update operation on weak-consistent distributed state information, the method comprising:
durably storing an update-operation description that specifies at least one update dependency associated with the update operation;
durably storing primary data to be used for performing a step of the update operation on the primary computer system and dependent data to be used for performing a step of the update operation on at least one dependent computer system;
durably storing an information unit indicating an intention to send the dependent data to the at least one dependent computer system in accordance with the update-operation description;
sending the dependent data to the at least one dependent computer system in accordance with the update-operation description; and
upon receiving, from the at least one dependent computer system, an indication of acceptance of the dependent data, durably storing an information unit indicating that the at least one dependent computer system accepted the dependent data.

2. The method of claim 1, wherein the update-operation description specifies at least one primary operation to be performed by the primary computer system.

3. The method of claim 1, wherein the update-operation description is specified in terms of a directed acyclic graph of update dependencies.

4. The method of claim 1, further comprising: durably storing an indication of an order in which a plurality of update operations are to be performed.

5. The method of claim 4, further comprising: durably storing an indication of a last-performed update operation from the plurality of update operations to be performed.

6. The method of claim 5, further comprising: using the stored indication of a last-performed update operation and the stored indication of an order in which update operations are to be performed to determine whether or not a particular update operation has been performed.

7. The method of claim 4, further comprising: using sequence numbers to uniquely identify instances of update operations.

8. The method of claim 1, further comprising: durably storing information pertaining to a plurality of performed update operations thereby enabling replaying of the update operations in the future.

9. The method of claim 8, further comprising: replaying a plurality of the performed update operations for which pertinent information was previously stored such that:
fault-recovery update operations and normal update operations are processed in substantially the same way, and
the update operations are replayed by at least one of the primary-computer system and a computer system not involved in originally performing the replayed update operations.

10. The method of claim 1, further comprising: for a particular update operation, durably storing at the primary computer system substantially all primary data targeted for storage at the primary computer system and substantially all dependent data targeted for storage at the at least one dependent computer system.

11. The method of claim 1, further comprising: durably storing a plurality of serialized information units specifying that the primary computer system will send dependent data associated with a plurality of update operations to a plurality of dependent computer systems.

12. The method of claim 11, further comprising: sending the dependent data to the plurality of dependent computer systems in accordance with an order in which the serialized information units were stored.

13. The method of claim 12, further comprising: upon receiving, from the at least one dependent computer system, an indication of completion of dependent operations associated with the dependent data, durably storing at least one information unit indicating completion of the dependent operations.

14. A method, performed by a dependent computer system, of asynchronously performing an update operation on weak-consistent distributed state information, the method comprising:
receiving, from a primary computer system, dependent data that is associated with the update operation;
durably storing the dependent data and then providing an indication to the primary computer system that the dependent computer system has accepted the dependent data;
durably storing an information unit specifying that the secondary computer system will perform local processing associated with the dependent data;
performing the local processing associated with the dependent data; and
durably storing an information unit indicating that the dependent computer system performed the local processing associated with the dependent data.

15. The method of claim 14, further comprising: storing an indication of an order in which a plurality of dependent operations, which are associated with the dependent data, are to be performed.

16. The method of claim 15, further comprising: storing an indication of a last-performed dependent operation from the plurality of dependent operations to be performed.

17. The method of claim 16, further comprising: using the stored indication of a last-performed dependent operation and the stored indication of an order in which the dependent operations are to be performed to determine whether or not a particular dependent operation has been performed.

18. The method of claim 14, further comprising: storing information pertaining to a plurality of performed dependent operations thereby enabling replaying of the dependent operations in the future.

19. The method of claim 18, further comprising: replaying a plurality of the performed dependent operations for which pertinent information was previously stored.

20. The method of claim 14, wherein, upon failure of the at least one dependent operation to be performed by the dependent computer system, notifying the primary computer system that the at least one dependent operation to be performed by the dependent computer system has failed.

21. The method of claim 20, wherein:
before notifying the primary computer system that the at least one dependent operation to be performed by the dependent computer system has failed, storing an intention record indicating an intention to notify the primary computer of the failure; and
after notifying the primary computer system that the at least one dependent operation to be performed by the dependent computer system has failed, storing a log record indicating that the primary computer system was notified of the failure.

22. The method of claim 14, further comprising
storing an intention-log record specifying that the secondary computer system will send dependent data stored at the secondary computer system to at least one additional dependent computer system;
sending the dependent data stored at the secondary computer system to the at least one additional dependent computer system; and
upon receiving, from the at least one additional dependent computer system, an indication of acceptance of the dependent data stored at the secondary computer, storing a log record indicating that the at least one additional dependent computer system accepted the dependent data stored at the secondary computer system.

23. A system that asynchronously processes update operations associated with weak-consistent distributed state information, the system comprising:
a primary information-storage site that stores
a plurality of directed acyclic graphs of update dependencies associated respectively with the update operations,
serialized intention-log records of update operations to be performed, and
log records indicating update operations that have been performed; and
at least one dependent information-storage site that:
checks for continuity of counter-sequence values in update information received from the primary information-storage site to detect gaps in, and repeats of, the update information received from the primary information-storage site,
upon detecting a gap in the update information, informs the primary information-storage site that the gap was detected, and
upon detecting a repeat of received update information, ignores the repeated update information.

24. The system of claim 23, wherein, for at least one update operation, the primary information-storage site stores substantially all update information to be used by the primary information-storage site and by the at least one dependent information-storage site.

25. The system of claim 23, wherein dependent site-update information, which is stored at the primary information-storage site, is divided into logical units targeted to various dependent information-storage sites.

26. The system of claim 23, wherein, before sending update information from the primary information-storage site to a dependent information-storage site, the primary information-storage site determines whether any update information negates any other update information to be sent to the dependent information-storage site, and, upon detecting such a negation, removing the negated information from the update information to be sent to the dependent information-storage site.

27. The system of claim 26, wherein:
before removing the negated information from the update information to be sent to the dependent information-storage site, the primary information-storage site stores an intention record indicating an intention to remove the negated information; and
after removing the negated information from the update information to be sent to the dependent information-storage site, the primary information-storage site stores a log record indicating that the negated information was removed from the update information to be sent to the dependent information-storage site.

28. The system of claim 23, wherein, upon detecting an out-of-synchronization condition, the primary information-storage site and at least one of the dependent information-storage sites synchronize their respective state information.

29. The system of claim 28, wherein, the primary information-storage site sends state information to at least one of the dependent information-storage sites in response to receiving a synchronization request from the at least one of the dependent information-storage sites.

30. The system of claim 28, wherein, the primary information-storage site sends state information to at least one of the dependent information-storage sites in response to the at least one of the dependent information-storage sites starting up, recovering from a failure, or re-establishing a connection with the primary information-storage site.

31. The system of claim 28, wherein, when the primary site is behind in time relative to at least one of the dependent sites, then compensatory actions are taken to roll back in time state information stored by the at least one dependent information-storage site.
